(19) United States
(12) Patent Application Publication
(10) Pub. No.: US 2008/0062377 A1
(43) Pub. Date: Mar. 13, 2008

(54) Visibility Means for Eyeglasses

(76) Inventor: P. Kenneth Weidler, Gladwyne, PA (US)

Correspondence Address: P. KENNETH WEIDLER, 1508 SWEET BRIAR RD., GLADWYNE, PA, 19035, US

(21) Appl. No.: 11/467,521

(22) Filed: Aug. 25, 2006

(51) Int. Cl. G02C 1/00

(52) U.S. Cl. 351/43

(57) ABSTRACT

The invention promotes visibility when applied to a conventional pair of eyeglasses on land or in water and in lit or dark conditions such as the incorporation of colorization, luminescence or reflectivity to the invention. The invention can additionally comprise removable buoyancy applied to the eyeglass temple pieces which causes floatation of the eyeglasses should they be dislodged from the wearer in water. The invention can be selectively attached to a desired position on the temple piece and additional weight or buoyancy can be selectively and removably added to it to increase its visibility. The invention can also provide for personalization.

### RELATED APPLICATIONS

Applicant has no other prior or copending U.S. Patent applications, including any provisional or non-provisional utility or design patent application, or any prior foreign or internationally filed applications on the invention, and makes no claim for any domestic or foreign priority in this application.

### STATEMENT OF GOVERNMENT INTEREST

There is no property interest of the government in any aspect of this invention. This invention was not made while the applicant was either under the employment of any government agency, or under any contract or grant from any government agency.

### BACKGROUND OF THE INVENTION

1. Field of the Invention

The present invention relates to promoting the visibility of eyeglasses and an optional buoyancy means to keep eyeglasses afloat and visible allowing their retrieval in the event the eyeglasses are either dislodged from the wearer or are accidentally dropped into the water.

The proposed primary classification for this invention is class 351, Optics, subclass 43, floating spectacles or eyeglasses.

2. State of the Prior Art

The prior art shows discloses various methods to alter the appearance of the temple pieces of eyeglasses but none shows separate elastomeric sheaths on each temple piece, that are not attached to each other, for promoting visibility of the eyeglasses. The prior art discloses various types of retainers or floats for eyeglasses. Methods have been shown to attach a floatation member to eyeglasses via a retainer which can be looped around the neck, arm or leg of the wearer. Other methods show customized frames which have float pads specifically made to fit these frames as a means of buoyancy. These floats are either bonded directly to the frames or are snapped into cutouts in the frames. Still other methods show elastomeric bands or loops attached to a floatation device through which the temple piece of the eyewear is fed in an attempt to secure the device to the temple piece. These bands or loops are permanently attached to the member and because they are of a predetermined size, they cannot effectively adapt to a variety sizes or shapes of different temple pieces. Yet another method incorporates a floatation member with internal slits that surround the temple portion of the frame and are held in place by elastomeric bands or alternatively by a conventional hook and loop means such as Velcro®. In this case, the slits can be widened to accommodate a thick temple piece however, once this is performed, it is irreversible. The prior art additionally discloses a floatation device wherein a longitudinal passage accommodates a temple piece, but the passage is such that a substantially major portion of the float member must be disposed on the lateral side of wearer's temple piece. None of the prior art provides a removable and reusable device that promotes upward tipping of the eyeglass temple pieces when floating in the water, or a removable and reusable device that can be easily adapted to securely fit temple pieces of various shapes and sizes. Also, none of the prior art teaches a customizable, easily reversible method of adding weight to the buoyancy means to alter the center of gravity of the spectacles, which in turn affects the visibility of the buoyancy means above the water's surface. The prior art shows a method to adhesively stack additional buoyancy members to a floatation device however it does not teach the reversible method of adding additional buoyancy members at a desired position along the floatation device. Furthermore, none of the prior art gives the end user a method to create enhanced visibility by the selective placement of the buoyancy member at various positions on the temple piece and/or selectively and reversibly adding buoyancy material and/or weight at a desired position along the buoyancy means. Additionally, the prior art does not teach how the shape of the buoyancy means influences the floatation properties of the combination of the buoyancy means on a pair of glasses in the water. The prior art shows a method to attach identification information to a pair of eyeglasses via a sleeve which is attached to the temple piece of the eyeglasses however, once this is done, the identification information cannot be easily removed or transferred to another pair of eyeglasses. Also in its preferred embodiment, it requires an intermediary recovery company to put the finder of the lost eyeglasses in touch with the owner of the eyeglasses.

### SUMMARY OF THE INVENTION

The invention promotes the visibility of eyeglasses either on land or in water. An exemplary embodiment of the invention promotes visibility in lit and/or dark conditions by providing colorization and/or reflectivity and/or luminescence. A sheath means of the invention can be utilized to incorporate these visibility features. The invention may additionally include the application of the buoyancy means to the temple pieces of a conventional pair or eyeglasses. If the eyeglasses fall into water, the buoyancy means provides visibility by preventing the eyeglasses from sinking below the surface of water into which they have fallen and can be readily attached to and removed from a conventional pair of eyeglasses. The buoyancy means comprises various means to facilitate upward tipping of the end of the eyeglass temple pieces remote from the lens frame portion of the eyeglasses, hereafter referred to as distal, when floating in the water. In many embodiments, the buoyancy means can be used in combination with the optional placement of a temple sheath disposed over at least the distal end of the temple pieces to increase visibility when floating in water and improve the visibility of the temple pieces on either land or water.

The buoyancy means comprises one or more buoyancy members made of a material with a specific gravity less than one and of a volume and density sufficient to effect floatation of the combination of the buoyancy means and the eyeglasses. The specific gravity and/or the volume of the buoyancy member may vary along its longitudinal direction and affect the floatation and/or visibility of the eyeglasses. The buoyancy means includes the attachment means for removably and selectively securing the buoyancy means to the eyeglasses at various positions along the temple piece. An exemplary embodiment incorporates a resisting means to resist movement of the buoyancy means on the temple piece.

An exemplary embodiment of the invention has the ability to adapt to and securely fit a variety of temple sizes and shapes and can be used interchangeably from one pair of frames to the next without the need to permanently alter the eyeglasses or the invention. The buoyancy member can be segmented or one piece and can completely surround the circumference of the temple piece, surround a part of it, or be completely external to it. Sheaths and/or mating means such as hook and loop members like Velcro® can be used as part of the attachment means to secure the buoyancy member to the temple piece. The sheath means can also be used to enhance the visibility and the comfort of the buoyancy means and to provide a means to add a weight member or an additional buoyancy member to it. An exemplary embodiment of the buoyancy means employs the use of a retainer means to provide a customizable, easily reversible system to add the weight member and/or the additional buoyancy member to a desired position along the buoyancy means which allows the buoyancy means to accommodate a wide variety of eyeglasses, each having a unique center of gravity, and to produce a tipping effect of the eyeglasses for improved visibility as they float. Another exemplary embodiment of the buoyancy means positions a greater volume of the buoyancy member inferior to the temple piece to promote desirable floatation properties and to enhance its visual appearance. Another exemplary embodiment of the buoyancy means places a greater volume of the buoyancy member towards the distal of the buoyancy means which also promotes desirable floatation properties. Furthermore, an exemplary embodiment of the buoyancy means has a means to personalize it with the user's contact information in the event the floating eyeglasses are lost and found by another individual. Also this identification information can be easily removed, transferred to a different pair of eyeglasses, if so desired, or can be easily amended or updated by simply attaching new contact information to the buoyancy means. This is an extremely efficient and inexpensive method to attach identification to the buoyancy means.

### BRIEF DESCRIPTION OF THE DRAWINGS

FIG. 1 shows a conventional pair of eyeglasses, wherein the temple pieces have a first end attached approximating the lens frame end of the eyeglasses, hereafter referred to as the proximal end or the lens frame end, and a second end approximating the earpiece end of the temple portion of the eyeglasses, hereafter referred to as the distal end.

FIG. 2 shows a temple piece of the eyeglasses of FIG. 1, with a temple sheath applied over the temple piece to enhance the visibility of the temple piece. FIG. 2A shows a cross-sectional view of the temple piece and the temple sheath of FIG. 2. The temple sheath may be employed over the temple piece in any embodiment of the invention.

FIGS. 2B, 3, and 3A show the buoyancy member applied to a temple piece of FIG. 2 to provide floatation of the eyeglasses. FIG. 2C demonstrates a tipping angle (a) relative to the surface of the water (w). FIG. 3 is a cross-sectional view of the embodiment of FIG. 2B. FIG. 3A shows a modification of the embodiment of FIG. 3 demonstrating a variable volume along the buoyancy member's longitudinal length.

FIG. 3B provides a cross-sectional view of FIG. 3, and FIGS. 3C-3I show cross sections of various embodiments of the buoyancy member to promote stability of the buoyancy member from rotation over the temple piece, durability of the buoyancy member, and comfort for the wearer.

FIG. 4 shows the application of an external float sheath surrounding the buoyancy member and the optional retention of the weight member or the additional buoyancy member to it. FIGS. 4, 4A-4G show various means for promoting upward projection of the temple pieces and downward projection of the lens frame portion when floating in the water.

FIG. 4B shows the additional application of a resisting member, such as a conventional O-ring, to resist axial movement of the buoyancy member towards the distal end of the eyeglass temple piece. Also shown are a flap means which may be used to secure the additional buoyancy member and/or the weight member anywhere along the length of the flaps. These flaps are attached to the external float sheath. In FIG. 4C, the flaps are part of the external float sheath which are further clarified by the cross sections shown in FIGS. 4D and 4E. FIGS. 4F and 4G show how the flaps are folded to secure the additional buoyancy member and/or the weight member.

FIG. 5 shows a cross-sectional view of the external float sheath surrounding the buoyancy member.

FIGS. 6 and 7 show a unitary sheath which combines the temple sheath and the external float sheath into a single sheath. FIG. 7 also shows the addition of a tab attached to the distal end of the unitary sheath to facilitate the removal of the buoyancy means from the eyeglasses.

FIGS. 7A and 7B show a variation of the unitary sheath in which the flap means are attached to it and the distal end of the temple portion of the sheath is open ended and extends beyond the temple piece thereby not restricting the positioning of the buoyancy means towards the proximal end of the eyeglasses and additionally functioning like the tab in FIG. 7 by facilitating the removal of the buoyancy means from the eyeglasses.

FIGS. 8 and 9 show the additional use of a constricting means to provide additional radial pressure of the buoyancy member against the temple piece.

FIGS. 10, 11, 11A, and 11B show various embodiments for attaching the buoyancy member to the temple piece. FIGS. 10, 11, and 11A show the use of an elastomer attached to the buoyancy member, and enclosing at least a portion of the temple piece. FIG. 11B shows the use of the external float sheath as a part of the attachment means.

FIGS. 11C and 11D show how the flap means can be used with this embodiment to secure the additional buoyancy member and/or the weight member. In FIG. 11C a single sheath is utilized to enclose part of the temple piece thereby forming a portion of the passage through which the temple piece passes, to function as the external sheath providing strength and visibility, and to form part of the flap means which can secure the additional buoyancy member and/or the weight member. In FIG. 11D the flap means are attached to the embodiment in FIG. 11B.

FIGS. 11E and 11F show alternate constructions of the buoyancy member to promote comfort against the temple region of the wearer, and to resist rotation of the buoyancy member when applied to the temple piece.

FIGS. 11G and 11H show means to resist longitudinal movement of the buoyancy member of FIG. 11B.

FIGS. 12-13I show the application of the attachment and retainer means surrounding the buoyancy member which dually functions as the attachment means to secure attachment of the buoyancy means to the temple piece at a specific position both vertically and longitudinally and as the retainer means to apply the weight member or the additional buoyancy member at a desired position along the attachment and retainer means. FIGS. 13F and 13I show a hook means to initially secure the buoyancy means to the temple piece by creating a purchase point to begin wrapping the attachment and retainer sheath around the temple piece and buoyancy member. FIG. 13G shows the use of the mating means to achieve similar results of the hook means of FIG. 13F. FIG. 13H shows the application of both the weight member and the additional buoyancy member to the buoyancy means.

FIG. 13J shows the application of the resisting means on the interior aspect of the buoyancy means that has a frictional surface which will contact the temple piece when applied to it and resist movement of the buoyancy means relative to the temple piece.

FIGS. 14-14B show the attachment and retainer means with multiple buoyancy members. As particularly shown in FIG. 14, the use of an attachment and retainer sheath permits the buoyancy member to be formed as plural circumferential segments surrounding the temple piece, and secured by the attachment and retainer sheath.

FIGS. 15-16 show possible constructions of the plural buoyancy members of FIG. 14.

FIGS. 17-21 show the buoyancy member attached proximate to, but not surrounding, the temple piece. Various means are shown to secure attachment of each buoyancy member proximate to an eyeglass temple piece.

### DETAILED DESCRIPTION

With reference to the accompanying drawings, following is a detailed description of the various embodiments of the invention, and disclosure of how to make and use the invention.

As used herein, the term “eyeglasses” refers to any form of spectacles or eyeglasses, including commercial, over-the-counter glasses, prescription eyeglasses, clear-lens eyeglasses and sunglasses. The invention is not dependent upon the specific construction of the eyeglasses.

The term “mating means” refers to a connecting means comprised of a first mating member which engages a second mating member and provides reversible securement to each other. An example would be Velcro® which has a hook member which engages its mate, a loop member, to secure the two members together. Another example would be a snap which has a male and female member which engage each other when in function. When mating members are viewed in the drawings, unless otherwise described, it is to be understood that the mating members with different reference numerals in the same drawing are mates meant to engage each other. For instance, one numeral would represent the hook member and the other numeral would represent the loop member and that their engaging surfaces face each other when the buoyancy means is applied to the temple piece. For ease of viewing, one mate is single hatched and the other is cross hatched in the drawings. In the exemplary embodiments shown in the drawings, hook and loop members are shown and described as comprising the mating means but the mating means could be any conventional mating members.

The term “attachment means” refers to the means used to attach the buoyancy means to the temple piece. It could be a longitudinal passage formed entirely or partly by the buoyancy member, or it could be a longitudinal passage formed entirely or partly by the sheath, or it could be formed of a mating means with or without the use of an attachment sheath.

The term “retainer means” is a means to reversibly add the weight member and/or the additional buoyancy member to the buoyancy means. It can be comprised of the “flap means” in which flaps with mating members are used to secure the additional weight member and/or the additional buoyancy member. It can be made of the mating means or the mating means attached to the sheath means. In some embodiments, the attachment means can dually function as the retainer means in which it not only secures the buoyancy means to the temple piece but also provides a means to reversibly add the weight member and/or the additional buoyancy member to the buoyancy means. The retainer means could utilize other conventional means to secure additional weight members and/or buoyancy members such as pockets, pouches etc.

The term “buoyancy member” refers only to the portion of the buoyancy means with a specific gravity less than one which ultimately provides the buoyancy force necessary to overcome the weight of the combination of the buoyancy means and the eyeglasses and cause floatation of the combination when placed in water. The “buoyancy means” comprises at least one buoyancy member and the attachment means for attachment of the buoyancy means to the eyeglass temple piece and may optionally include retainer means.

The term “tipping angle” or “angle of stability” (a) as used herein refers to the angle formed between the surface of the water (horizontal in the drawings) and the final position of the temple piece once the tipping has occurred. The tipping angle can be varied to maximize the visibility of the combination.

The term “removable means” refers to any additional means that can be added to the buoyancy means that has a net specific gravity greater or less than one that will allow the user to affect the floatation and/or the tipping angle of the floating eyeglasses. The removable means could be a removable member itself or the removable member with a mating means attached to it to engage the mating means of the buoyancy means. A removable member that has a specific gravity less than one will be referred to here after as the “additional buoyancy member” or a “secondary buoyancy member” and a removable means that has a specific gravity greater than one will be referred to here after as a “weight member”.

The “sheath means” refers to the sheath portions of the buoyancy means which could be part of the attachment means and/or the retainer means and/or the flap means of the buoyancy means, could aid in connecting the various components of the buoyancy means into a unitary assembly, could aid in the removal of the buoyancy means from the temple piece, could aid in visibility properties including colorization, reflectivity and luminescence, could promote durability of the buoyancy means, and could promote comfort of the buoyancy means. The sheath means could be the sheath itself that incorporates colorization, and/or reflectivity and/or luminescence or the sheath and a member added to it to promote visibility such as colorization, and/or reflectivity and/or luminescence. The sheath means could be the temple sheath alone or any of the sheaths comprising the buoyancy means.

The term “center of buoyancy” as used herein refers to the point at which a single force vector could be placed to describe the buoyancy force on an object. The object could be the buoyancy member or means itself, or the combination of the buoyancy means and the eyeglass frames. In a stable position in the water, the center of buoyancy will be on a vertical line passing through the center of gravity so no net torquing forces are acting upon the object. If the object is in water at any other angle than the angle of stability, the center of buoyancy will have moved off the vertical axis passing through the center of gravity thereby creating torquing forces which will rotate the object and return it to the angle of stability.

The buoyant force acts on the object at the center of gravity of the displaced liquid. This will also be the center of volume of that portion of the object that is below the water, since the displaced water has a uniform density. This point is called the center of buoyancy. Floatation of the object will occur with the upper surface level of the object at the water line when the density of the object is the same as the liquid. If the density of the object is lower than that of the liquid, its net weight will be less than the buoyancy force, and a portion of the object will project above the water line. For the object to float stably, the center of gravity and the center of buoyancy must remain in a vertical line so that there is no net torque acting on the floating body causing it to rotate. In the equilibrium position of the floating object, the vertical line passing through the center of gravity is called the “centerline” of the object and is fixed with respect to the body.

In reality, the floating object will rarely come to rest at the tipping angle because in a pool, lake, ocean etc., there will almost always be some external forces acting upon the object such as ripples or waves in the water or wind. When these external forces act upon the floating object, the object is displaced from its state of equilibrium or stability and the center of buoyancy shifts off the center line, thus coupling forces are generated which produces a net torque which will try to right the object and return it to its state of equilibrium. Therefore, the floating object will almost always be swaying around its tipping angle. From a visibility standpoint, this movement can be advantageous in attracting the eye.

In each embodiment of the invention, a visibility means, which could be the sheath means and/or the buoyancy means, is applied to the temple piece of eyeglasses. In each embodiment of the buoyancy means disclosed herein, the buoyancy means extends longitudinally along or around a portion of the eyeglass temple piece. Upward tipping of the distal end of the eyeglass temple pieces is achieved in the various embodiments of the buoyancy means either by varying the longitudinal placement of the buoyancy means along the temple piece, by varying the density and/or volume of the buoyancy member along its longitudinal direction, or by applying additional weight to the buoyancy means near its proximal end.

Each drawing figure that shows a cross section of the temple piece and/or buoyancy member of the invention is oriented such that the temple region of the wearer will be to the right-hand side of the drawing. The buoyancy member or buoyancy members of the buoyancy means are formed of a material with an overall specific gravity less than one, such as a closed cell foam, and the buoyancy means contains sufficient volume of the buoyancy member or buoyancy members to overcome the weight of the combination of the buoyancy means, the eyeglasses and the optional temple sheath and cause floatation. A primary buoyancy member is permanently attached to the buoyancy means and the optional secondary buoyancy member can be reversibly added to the buoyancy means to achieve additional floatation. The primary and secondary buoyancy members can be made of the same material or different materials and can each have a varying density and/or volume along their length. Each embodiment hereafter can optionally contain a personalization means such as a trademark and/or logo and/or user information such as identification or contact information in the event that the floating eyeglasses are lost and then recovered by another individual. This could be in the form of a small piece of paper which is laminated to protect it from the water. It could be attached to the buoyancy means by any conventional means such as by bonding or by having a mating member bonded to its underside which will engage the mating member of the various embodiments of the buoyancy means. If the personalization means is attached to the buoyancy means via a mating member, then the personalization can be easily applied, removed, transferred, amended or updated. The personalization means could also be imprinted, embossed or otherwise incorporated by any conventional means to the sheath means or any visible internal and/or external part of the invention. The same customization applies for any information in general such as adding corporate logos or adding advertising information to the invention.

FIG. 1 is a depiction of a conventional pair of eyeglasses, having a pair of temple pieces 100 attached to a conventional lens frame portion 103 of the eyeglasses. For reference purposes in later description of the invention, each temple piece 100 of the eyeglasses has a “distal end” 101 or earpiece end, and a “proximal end” 102 attached to the lens frame 103. The cross section of each temple piece may be freeform or may be of a conventional shape, including circular, ovular, or oblong, and may be of varied thickness, ranging from wire-rims to thickened members. The invention is applicable to most conventional eyeglass temple pieces.

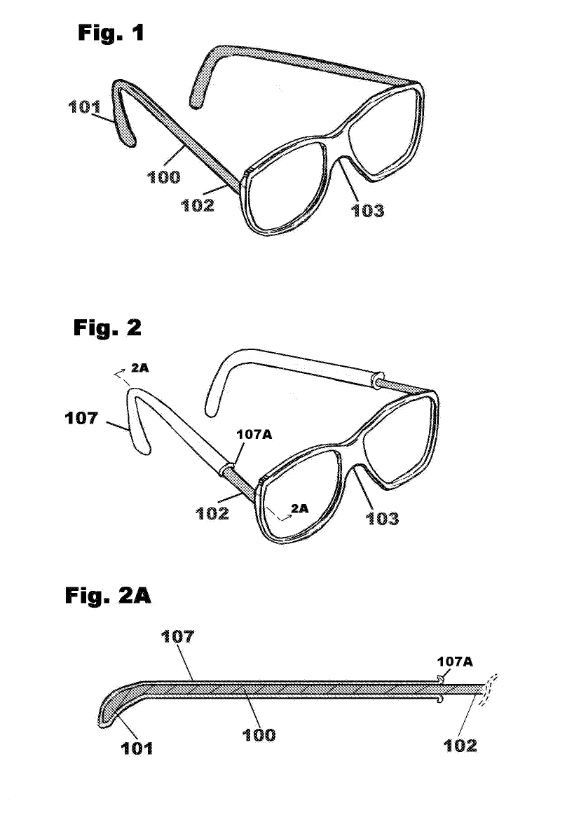

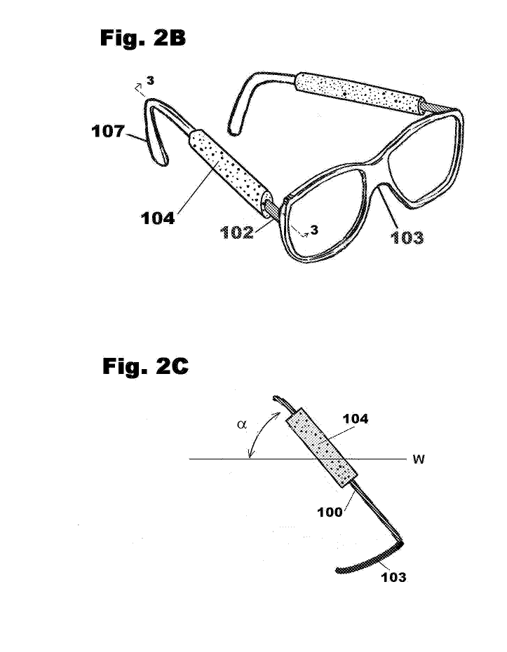

FIG. 2 shows the application of a temple sheath 107 over at least the distal end 101 of each temple piece 100. Temple sheath 107 is formed of a conventional resilient and flexible material. In a preferred embodiment this material is elastomeric, such as Spandex®, Lycra®, Latex®, or Nitrile®, that snuggly conforms to the temple piece 100 and allows for its reuse and its easy application and removal from the temple piece. In a preferred embodiment, if the elastomeric material is a woven fiber such as Spandex® or Lycra®, the seam is positioned at the distal end of the sheath, as in a sock or stocking, and does not span the longitudinal length of the sheath. In an exemplary embodiment, temple sheath 107 is durable, thin and brightly colorized, at least at the distal end 101 thereof, to promote visibility of the eyeglasses both when employed alone or when used with the buoyancy member, as shown in subsequent drawing figures. Although it is shown in many of the drawings, temple sheath 107 is optionally used by the wearer and is not mandatory to wear for the buoyancy means to function. In all embodiments, a temple sheath could be placed on the temple piece. It can cover just the distal end of the temple piece or can extend the entire length of the temple piece. FIG. 2A shows a cross-sectional view along section line 2A of FIG. 2. In an exemplary embodiment of the temple sheath, its proximal end has a raised rim of material, a gathered amount of material or an attached flexible structure 107A, such as an O-ring, similar to a prophylactic or finger cot, so that the sheath can be rolled out as it is applied to the temple piece and rolled back as it is removed. In an exemplary embodiment, the sheaths could come in a variety of colors giving the user the flexibility of changing the appearance of the temple piece if so desired. In another exemplary embodiment of the temple sheath, reflectivity is applied to the surface of the sheath or is applied by attaching a reflective means to the temple sheath, by any conventional means such as bonding, which would reflect light at night. This could offer protection to a walker, jogger, runner or biker at night from a lateral light source. It could also provide nighttime visibility if the floatable eyeglasses are dropped in the water and a light source such as a flashlight is shone upon it. In another exemplary embodiment of the temple sheath, luminescence is applied to the surface of the sheath or is applied to the sheath by attaching a luminescent means to it by any conventional means. The temple sheath could also be worn without the floatation device for visibility and/or aesthetic reasons.

FIG. 2B shows the application of the buoyancy member 104 over the temple piece 100 and temple sheath 107. For reference purposes, relative to how each buoyancy means or member will be positioned on the temple piece, the buoyancy means or member has a “proximal” end towards the lens frame end of the eyeglasses, a “distal” end towards the earpiece end of the eyeglasses, a “superior” and “inferior aspect, and a “medial” and “lateral” aspect so the invention can be described using these 3-dimensional terms. For purposes of comfort to the wearer, the distal end of the buoyancy member is positioned at a longitudinal point just in front of the ear of the wearer. Also placing the buoyancy member as far distally as possible while still being in front of the ear promotes a greater tipping angle and improved visibility in water.

FIG. 2C demonstrates the tipping angle (α) of the floating eyeglasses relative to the surface of the water at the equilibrium position. In various embodiments of the buoyancy means, the ability to customize the tipping angle to promote maximum visibility is emphasized.

In embodiments having a longitudinal passage, the attachment means is the longitudinal passage. The constrictivity of the material or materials forming the longitudinal passage affect the retention of the buoyancy means to the temple piece.

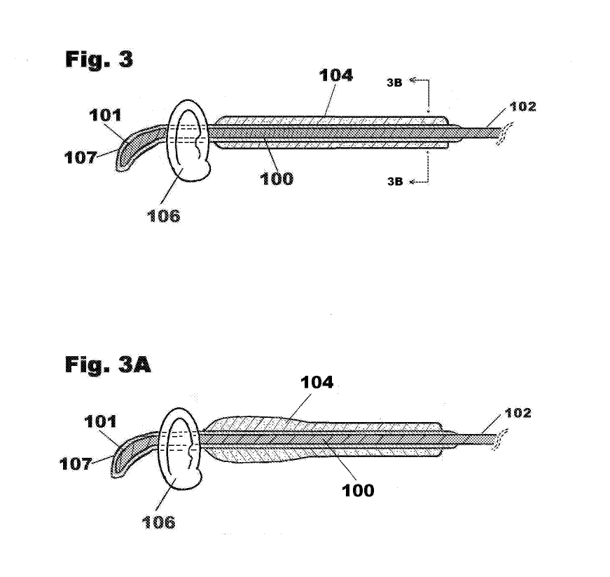

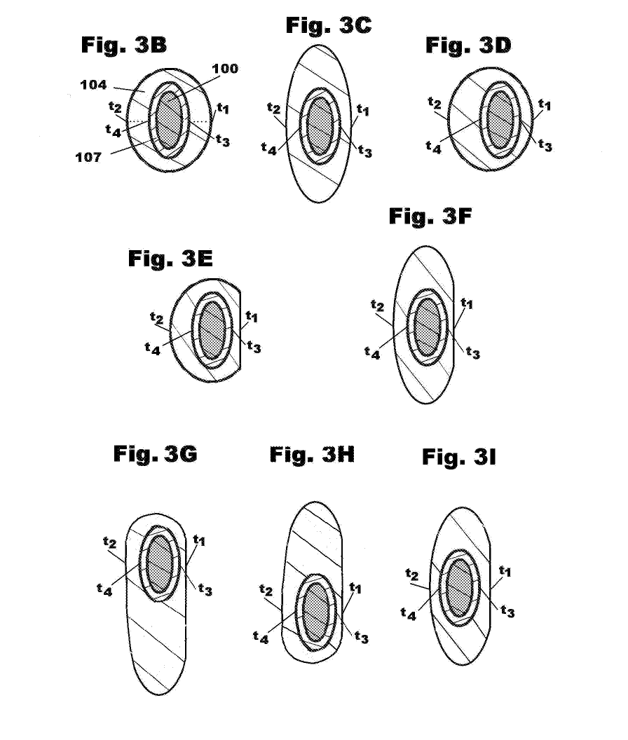

FIG. 3 shows a cross-sectional view of the buoyancy member 104, temple piece 100, and temple sheath 107 of FIG. 2B, and depicts positioning the distal end of the buoyancy member in front of the ear 106 of the wearer. Buoyancy member 104, and modifications thereof in subsequent embodiments, is formed of any conventional material having a specific gravity less than one, such as foam. In a preferred embodiment the buoyancy material is a closed cell low-density foam. Buoyancy member 104 surrounds the temple piece and has a longitudinal passage therein through which temple piece 100 and temple sheath 107 extend. The buoyancy member of any of the embodiments of the buoyancy means may be of any shape in cross section, including ovular, triangular, oblong or freeform. The longitudinal passage within the buoyancy member 104 is preferably of a cross-sectional shape and dimension congruent with and equal or slightly smaller than that of the temple piece upon which it is to be applied, thus forming a snug fit around the temple piece. Buoyancy member 104 is also preferably brightly colorized, at least towards the distal end 101 of each temple piece, to promote its visibility when floating in water. FIG. 3A, is a cross-sectional view of a modification of FIG. 3 which demonstrates that the buoyancy member need not have uniform volume along its length and can be of any shape. Furthermore, the buoyancy member and/or the buoyancy means can have varying densities along its length.

FIG. 3B is a cross-sectional view along section line 3B of FIG. 3, showing the temple piece 100 and temple sheath 107 extending through the longitudinal passage within the buoyancy member. FIGS. 3C-3H show various modifications of FIG. 3B to accommodate various considerations, as discussed in detail below. In each of FIGS. 3B-3H, the temple region of the wearer is to the right-hand side of the drawings. Points t₁-t₄ shown in FIGS. 3B-3H for references purposes fall on a line extending on a horizontal plane through the vertical midpoint of the temple piece and through the innermost and outmost points of the buoyancy member. Points t₃ and t₄ show the intersection of that line with surface of the longitudinal passage within the buoyancy member.

Construction of the buoyancy means represents consideration of several factors, including the necessary volume of the buoyancy member to produce the required floatation, durability for reuse thereof, visibility, comfort of the wearer, and rotational stability of the buoyancy means over the temple piece. To these ends, various modifications of the buoyancy member are shown in FIGS. 3B-3H. While each of FIGS. 3B-3H show an essentially ovular temple piece and buoyancy member for illustrative purposes, the buoyancy member may take any desired shape, including circular, oblong, rectangular, triangular, or freeform. Similarly, the longitudinal passage within the buoyancy member, while depicted as generally ovular, may have a cross-sectional shape congruent to that of the temple piece upon which the buoyancy member is to be applied. FIGS. 3B and 3C show embodiments where the medial distance t₁-t₃ and lateral distance t₂-t₄ are substantially equal, thus providing substantially equal portions of buoyancy material on each side of the temple piece to promote durability thereof over repeated use. FIGS. 3D-3H each show the distance t₁-t₃ being less than the distance t₂-t₄, thus providing less buoyancy material between the temple region of the wearer and the temple piece for improved comfort to the wearer. FIGS. 3E-3I show a planar surface on the inside of the buoyancy member proximate to the temple region of the user, promoting rotational stability of the buoyancy member over the temple piece during use. FIG. 3I shows a modification of FIG. 3F wherein the distance t₁-t₃ may be at least equal to or greater than the distance t₂-t₄, thus increasing the amount of buoyancy material in the region between the temple piece and temple of the wearer, and providing increased durability of that portion of the buoyancy member subject to the most wear during use, while retaining rotational stability and comfort to the wearer by means of the planar inner surface of the buoyancy member. FIGS. 3C and 3F-3I show elongation of the buoyancy member in the vertical direction to provide an increase in overall volume of buoyancy material. FIGS. 3G and 3H show the longitudinal passage offset from the member's horizontal and vertical centerline of volume. FIG. 3G shows a major portion of the buoyancy member below or inferior to the temple piece, and reduced volume above or superior to the temple piece FIG. 3H shows a major portion of the buoyancy member above the temple piece and reduced volume below the temple piece The specific construction of the buoyancy member can thus be manufactured to meet the specific needs of a wearer.

An exemplary embodiment also takes into account the importance of the shape of the buoyancy means. Specifically, the construction of the buoyancy means with a greater volume of its buoyancy member towards its distal end promotes an increased tipping angle and better visibility. Also placement of a greater volume of the buoyancy material inferior to the temple piece further enhances this phenomenon. Furthermore, the cross-sectional shape of the buoyancy member can vary from the distal end to the proximal end of the member. Near the distal end where the member will approximate the face of the wearer, a soft, comfortable member with a minimal volume of buoyancy material medially between the temple piece and the user's face is desirable. However, moving proximally along the buoyancy means in the area where the temple piece of the wearer starts to separate from the face, it is less critical to have an offset passage in the medial-lateral aspect however it may be advantageous to have the passage offset in a superior-inferior aspect as shown in FIGS. 3G and 3H. The construction places the bulk of the of buoyancy material away from the user's face occupying a greater vertical component than horizontal which produces a more streamlined appearance. Also having a minor portion of the buoyancy member medial to the temple piece along its entire length may produce a structural weakness with repeated use or by trying to place this on a temple piece which has a large cross-sectional circumference relative to the cross-sectional circumference of the longitudinal passage. In this case, the buoyancy member may perforate or rip through on its minor medial side proximate to its longitudinal passage.

This presents the manufacturer with a dilemma. A higher density, less floatable, more durable foam may be used which resists this potential weakness but comfort may be sacrificed. If a low density, more floatable, less durable foam is chosen, structural integrity is increased at the expense of a potentially less comfortable floatation device. A compromise regarding this manufacturing dilemma may be reached by not offsetting the longitudinal passage its entire length in a medial-lateral direction and/or using a different density of buoyancy material along a portion of the buoyancy member's length. These principles can be applied to any embodiment with a longitudinal passage. Also surrounding the buoyancy member with a sheath offers structural support for the longitudinal passage.

An exemplary aspect of all embodiments of the buoyancy means is to promote floatation of the eyeglasses with the distal end 101 of the temple piece projecting upwardly above the water's surface, and the lens frame portion 103 projecting downwardly below the water's surface. The bright colorization of the temple sheath 107 and/or the buoyancy member 104 promotes visibility of the eyeglasses when floating in water. The tipping of the eyeglasses to promote the desired upward projection of the temple pieces when floating in water may be accomplished by any of the embodiments previously disclosed.

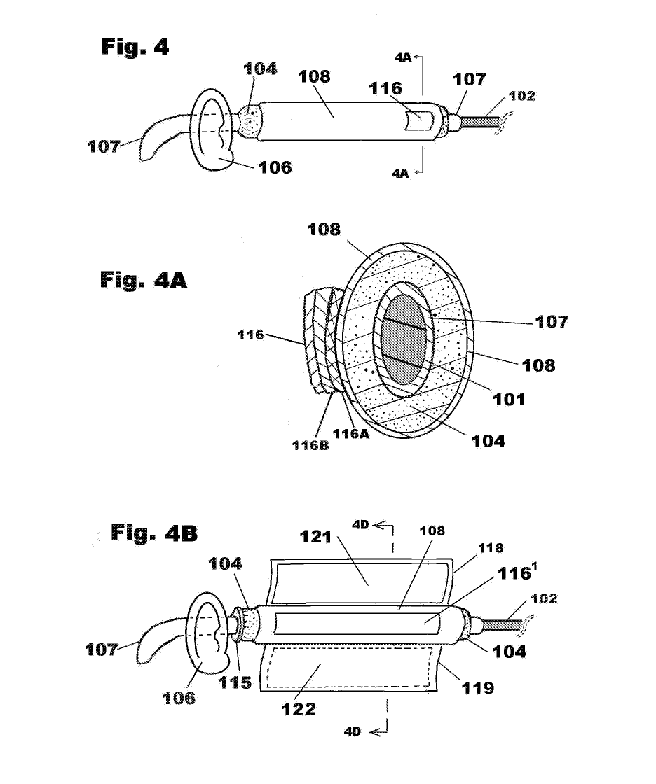

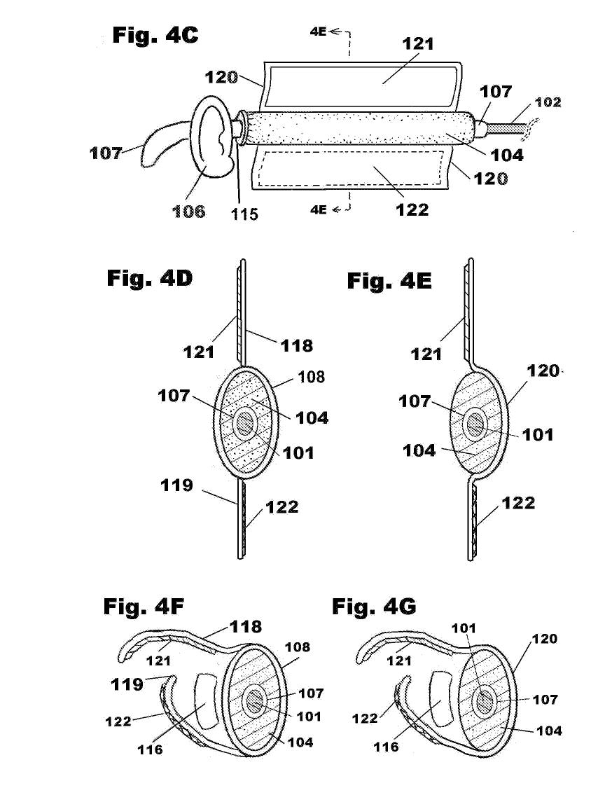

A float sheath 108 shown in each of FIGS. 4, 4A, 4B, and 5 is formed of a conventional resilient material. In a preferred embodiment the resilient material is an elastomeric material such as Spandex®. The float sheath surrounds and is attached to the buoyancy member 104 by any conventional means such as by bonding or stitching. In an exemplary embodiment, the adhesive used as the bonding agent, which connects various components of the invention, retains its properties in the presence of water and/or salt water and is flexible, such as any conventional elastomeric adhesive, allowing the structures which it is connecting to retain their flexibility. Float sheath 108 can extend the entire length of the buoyancy member as shown in FIG. 5, or a portion of it as shown in FIG. 4, can be brightly colorized, and can additionally provide a means to retain the removable means 116 to the combination. The removable means could be the secondary buoyancy member 116¹ or the weight member 116². The float sheath and all sheaths described hereafter and/or the buoyancy members can also have a reflective and/or luminescent surface to allow nighttime visibility as described previously with the temple sheath or can have a reflective or luminescent member attached to it to accomplish the same nighttime visibility. FIG. 4A shows mating member 116A attached to float sheath 108 by any conventional means such as bonding or stitching. Mating member 116B engages the mating member 116A. Bonded to the non-engaging surface of mating member 116B is removable means 116 which is either the weight member 116² or the secondary buoyancy member 116¹. In a preferred embodiment, mating members 116A and 116B are hook/loop members. The removable means can come in various volumes, densities or weights giving the user flexibility in improving the tipping angle and visibility and/or floatation of the floating eyeglasses.

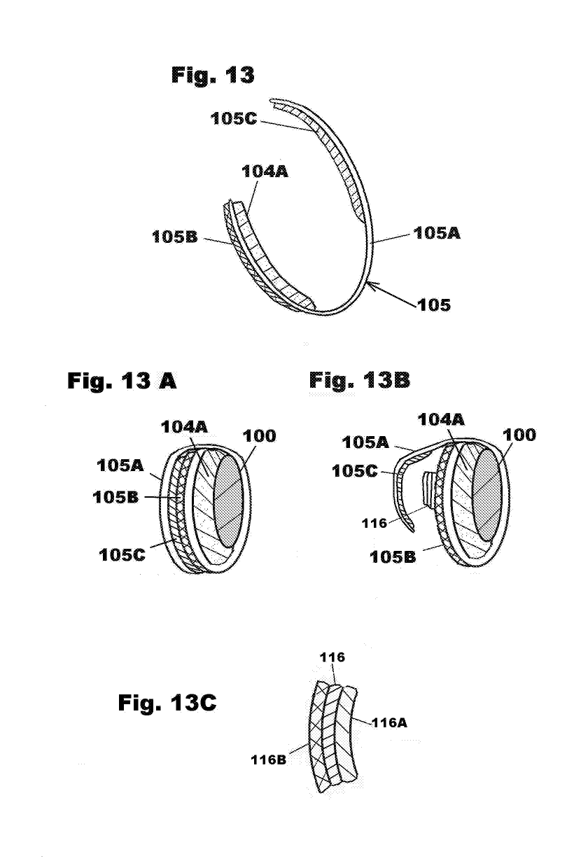

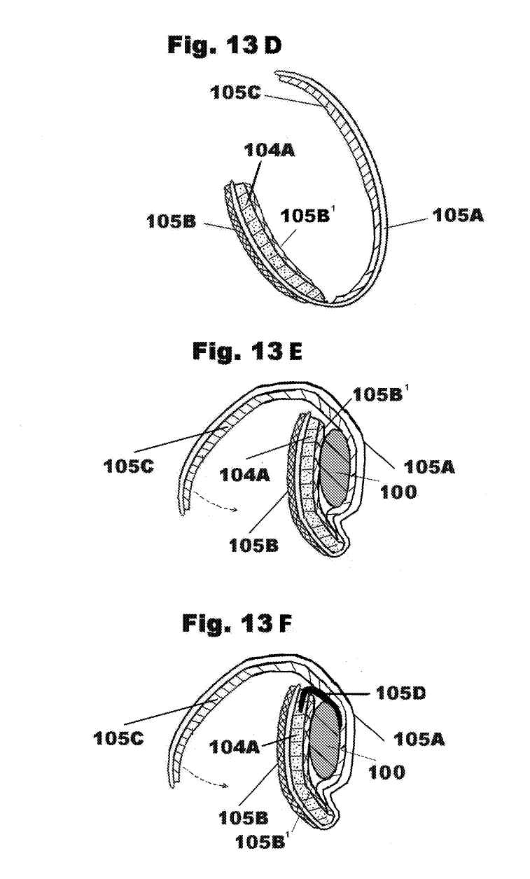

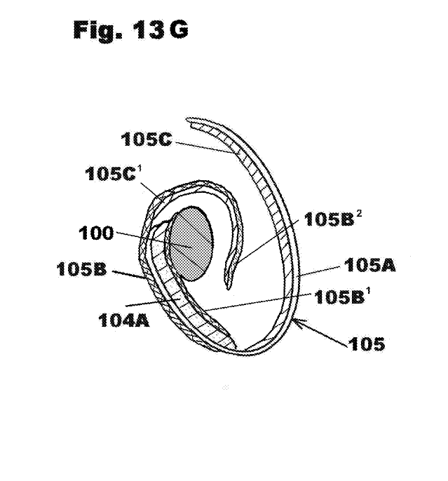

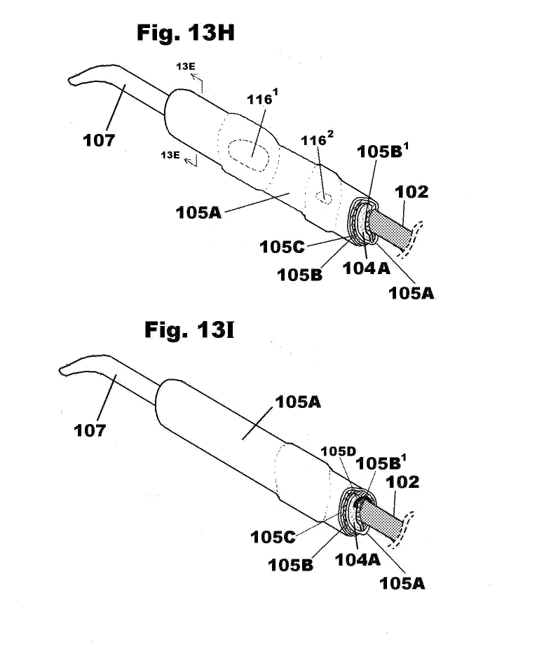

FIG. 4B is a modification of prior embodiments of the buoyancy means, with the application of the resisting means 115 around the temple piece 100 and temple sheath 107 and abutting the buoyancy member 104 to resist longitudinal movement of the buoyancy means towards the distal end 101. Although shown abutting the distal end of the buoyancy means, the resisting means could also be placed abutting the proximal end of the buoyancy means to resist proximal movement. Resisting means 115 can be comprised of a removable resisting means, such as a conventional O-ring, which can be readily applied and removed. Resisting means 115 may be used with any embodiment of the buoyancy means disclosed herein. Additionally, FIG. 4B shows the flap means in which retainer flap sheaths 118 and 119 are formed of a conventional elastomeric material, such as Spandex®, and attached to float sheath 108 by any conventional means such as stitching. Attached by conventional means, such as bonding or stitching, to each flap on opposite sides are mating members 121 and 122 which are used to secure the flaps to each other when folded together. Alternately, mating members 121 and 122 can be attached directly to the float sheath 108 by conventional means such as bonding or stitching. The retainer means are then used to easily attach and then remove the removable means 116 to the buoyancy means anywhere along the length of the flaps. Shown for demonstration purposes in FIG. 4B is the secondary buoyancy member 1161 extending almost the longitudinal entire length of the retainer mating flaps. In an exemplary embodiment, the retainer means extends along most of the longitudinal length of the buoyancy member which gives the user the greatest flexibility in positioning the removable means. In an exemplary embodiment, the removable means has a mating member attached to one side as shown in FIG. 4A or opposite mating members attached to opposite sides as shown in FIG. 13C. The mating means of the removable means allow its easy attachment to the mating means of the buoyancy means so the user does not have to try to hold the removable member in place as he wraps the retainer means around it. Also, when the retainer mating means of the buoyancy means are disengaged, the mated removable means does not simply fall out and risk its potential loss. Additionally, the mated removable means can be secured at a specific position both vertically and longitudinally within the retainer means of the buoyancy means and thereby less subject to movement within the retainer means. Movement of the removable means within the retainer means of the buoyancy means could potentially change the tipping angle. Via the retainer means, the user has the ability to add buoyancy material to the buoyancy means, if needed, and also create the tipping angle of his choosing for increased visibility. A small amount and/or volume of weight can be added via the retainer means near their proximal ends which could dramatically affect the tipping angle and improve the visibility of the floating eyeglasses. The secondary buoyancy member can extend the entire length of the flaps as depicted in FIG. 4B, can be of any size which fits between the flaps and can be positioned anywhere along the length of the flaps. Also the material comprising the secondary buoyancy member can be different than the material comprising the primary buoyancy member of the buoyancy means. Since the secondary buoyancy member is not next to the user's face and is not stressed by taking the buoyancy means on and off of the eyeglasses, comfort and durability are not necessary criteria for it. Any buoyant material with a specific gravity less than one, such as bubble pack material or foam, could be used to form the secondary buoyancy member. The positioning of the secondary buoyancy member towards the distal end of the flap means also affects the tipping angle and increases visibility. Via these retainer means and the ability to add the weight member and/or the secondary buoyancy member at a desired position within the retainer means, the user could create a desired floatation effect on a pair of eyeglasses and then place the buoyancy means on a different pair of glasses with a different center of gravity and, through the same method, produce a similar floatation effect on the new pair of eyeglasses. The embodiments shown in FIGS. 4-4G, FIGS. 7-7A, FIGS. 11C-11D, FIG. 12-12C, FIGS. 13-13I, FIGS. 14-14B and FIGS. 17-21 can all use their mating means to achieve the effects listed above.

FIG. 4C is a variation of the embodiment shown in FIG. 4B in which the single retainer sheath 120 functions like the float sheath 108 and the retainer flap sheaths 118 and 119 of FIG. 4B. A cross section of FIG. 4B and FIG. 4C is shown in FIG. 4D and FIG. 4E respectively and the application of each to retain the removable means 116 is shown in FIGS. 4F and 4G. The single retainer sheath 120 could also be attached by any conventional means such as bonding or stitching to float sheath 108 shown in FIG. 4D which would be used in place of retainer flap sheaths 118 and 119.

FIG. 5 shows a cross-sectional view of the external float sheath surrounding the buoyancy member. Float sheath 108 may be applied to any prior embodiment of the buoyancy means, and is preferably formed of a flexible elastomeric member, such as Spandex®. Float sheath 108 is preferably brightly colorized, at least towards the distal end 101 thereof, to further promote visibility of the eyeglasses when floating in water. Float sheath 108 extends over a substantial portion of buoyancy member 104 and may additionally extend to cover the entire member, or extend beyond the buoyancy member, and over the temple piece 100 towards the distal and/or proximal ends thereof.

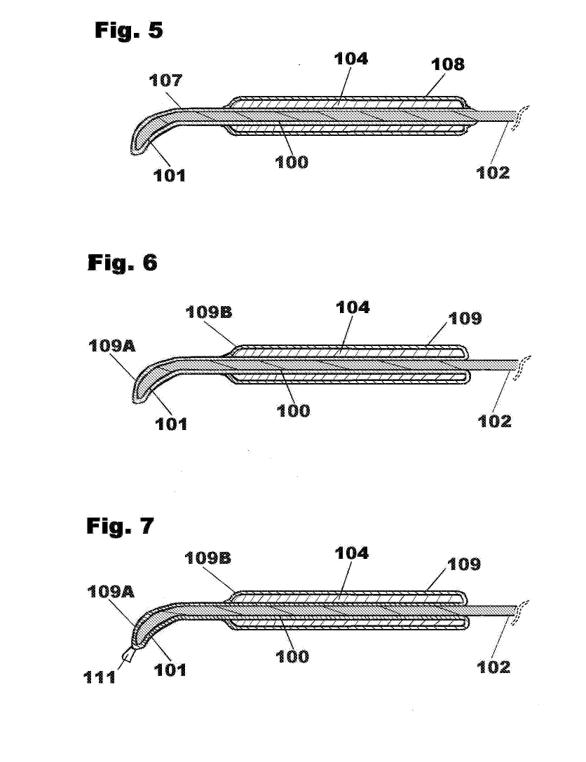

FIG. 6 is a modification of FIG. 5, and shows the unitary sheath 109 extending interior and exterior of the buoyancy member 104, and performing the combined functions of the temple sheath 107 and float sheath 108 of FIG. 5. Both ends 109A and 109B of unitary sheath 109 are preferably brightly colorized to promote visibility of the buoyancy means when floating in water.

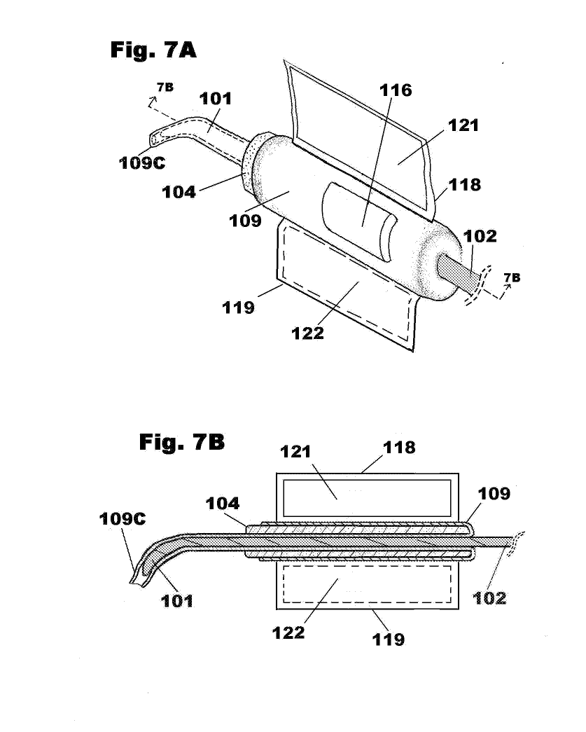

FIG. 7 shows a modification of FIG. 6 wherein the unitary sheath 109 combines the temple sheath and the external float sheath into a single sheath which is bonded to the exterior surface of buoyancy member 104, thus forming a single, unitary assembly. The entire assembly of sheath 109 and buoyancy member 104 of FIG. 7 may be inserted and removed as an integral assembly. Once applied over temple piece 100, the tab member 111, which is stitched or bonded to end 109A of the sheath 109 or formed as an integral part of sheath 109, may be grasped by the wearer to facilitate the removal of the unitary member 109/104 from the temple piece 100. The tab also helps keep the distal end of the unitary sheath from passing into or thru the longitudinal passage when the buoyancy means is removed from the temple piece.

FIG. 7A shows a variation of the unitary sheath with an open end 109C which has excess material extending past the distal end of the temple piece when positioned on the eyeglasses. This open end will not restrict the proximal placement of the buoyancy means on the temple piece and the excess material functions like the tab 111 of FIG. 7 to facilitate removal of the buoyancy means from the temple piece. The unitary sheath does not have to cover the entire external length of the buoyancy member. Additionally, retainer flap sheaths 118 and 119 have been attached to the unitary sheath by any conventional means such as stitching.

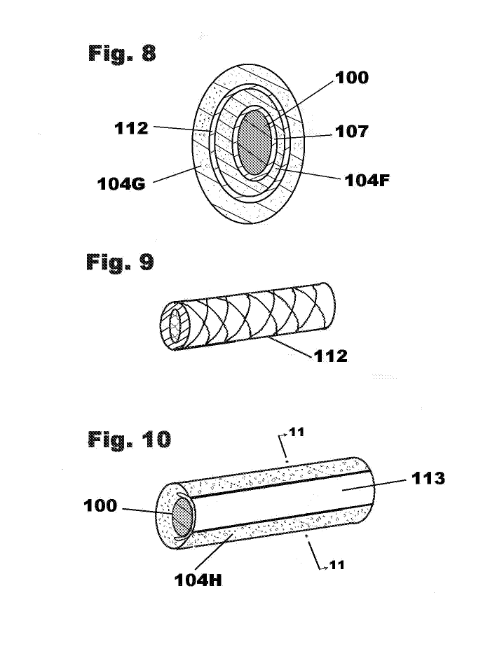

FIGS. 8 and 9 show the optional use of the longitudinal constricting means embedded within buoyancy member. As shown in FIG. 8, constricting member 112 is embedded between portions 104F and 104G of buoyancy member. FIG. 9 provides a perspective view of the constricting member 112, which is preferably formed as a braided member, commonly referred to as a “Chinese Finger Trap.” When disposed between buoyancy portions 104F and 104G, constricting member 112 resists longitudinal axial movement of the buoyancy member along the temple piece towards either the distal or proximal ends thereof. However, due to the flexibility of the buoyancy member and constricting member 112, inward axial pressure from the ends of the buoyancy member will release the constricting pressure of member 112, and permit removal of the buoyancy means from the temple piece.

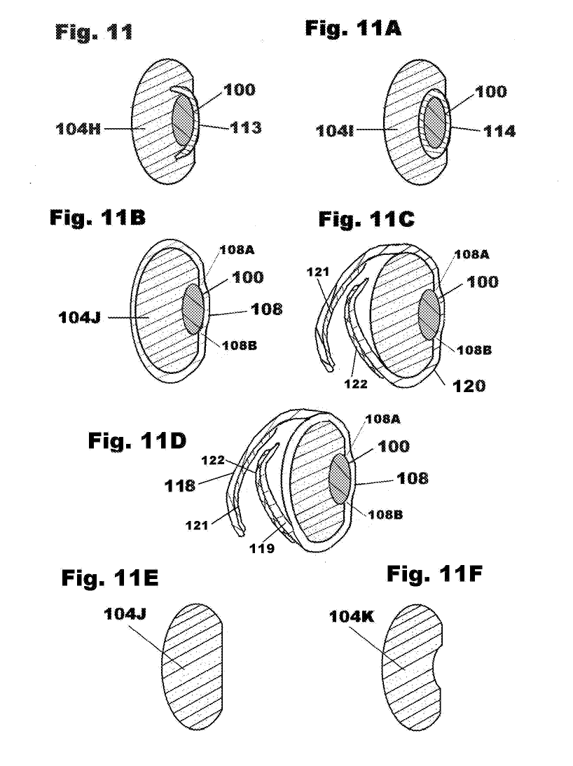

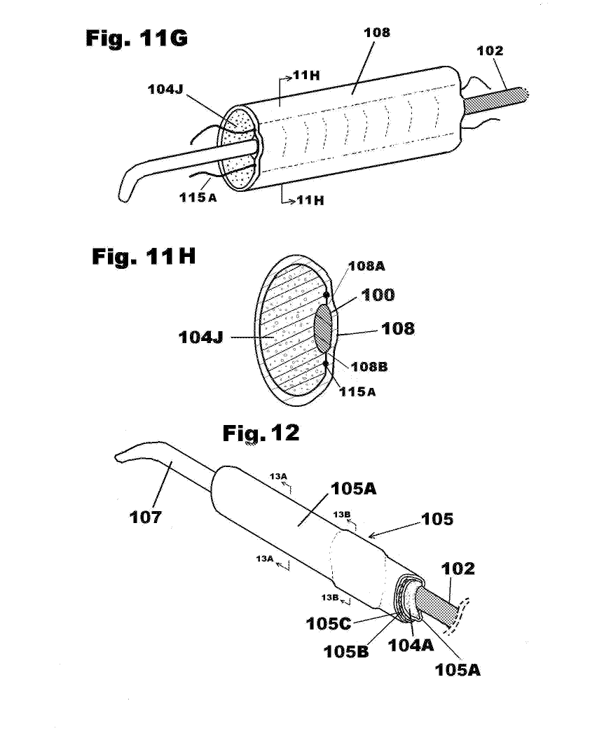

FIGS. 10, 11, and 11A-D show alternate embodiments of the buoyancy means where the buoyancy member has no component medial to the temple piece, with the longitudinal passage therein having a portion facing the temple of the wearer formed of a thin, soft elastomeric material for the purposes of improved comfort for the wearer and better accommodation of temple pieces of varying sizes. In FIGS. 11 and 11A, the portion of the buoyancy member proximate to the temple region of the wearer is replaced by an elastomeric member 113 or 114, such as Spandex®, that is attached to the buoyancy member, such as by bonding. As shown in FIG. 11, the elastomeric member 113 may be embedded within modified buoyancy member 104H. As shown in FIG. 11A, the elastomeric member 114 is attached to the buoyancy member 104I, thus forming a longitudinal passage within the buoyancy member. Elastomeric members 113 and 114 provide multiple functions. They decrease the bulk of the buoyancy means proximate to the wearer's temple region, they provide more comfort against the wearer's temple region, and the elastic nature of the material can better accommodate temple pieces of various sizes.

FIG. 11B shows use of the elastomeric float sheath 108, as shown in FIGS. 3C, 3D, 4, and 5, to form a passage for receiving the temple piece 100. Elastomeric sheath 108 is attached, such as by bonding, to buoyancy member 104J circumferentially counterclockwise from location 108A to 108B, as viewed in FIG. 11B. Elastomeric sheath 108 in not attached to buoyancy member 104J in the circumferential portion extending clockwise from 108A to 108B, as viewed in FIG. 11B. Temple piece 100 is disposed in the longitudinal passage within the buoyancy member between buoyancy member 104J and the unattached portion of elastomeric sheath 108. FIG. 11C shows how this embodiment can use sheath 120 to function as part of the attachment means enclosing part of the temple piece and thereby forming a portion of the passage through which the temple piece passes, to function as the external sheath providing strength, durability and visibility, and to form part of the retainer means which can secure the secondary buoyancy member and/or the weight member. FIG. 11D shows the attachment, by any conventional means such as stitching, of the retainer means comprised of retainer flap sheaths 118 and 119 and mating members 121 and 122 to the float sheath 108.

FIG. 11E shows buoyancy member 104J, as applied in FIG. 11B. In a preferred embodiment, buoyancy member 104J is formed of a flexible material, such as a conventional compressible low-density closed cell foam, that will deform when in contact with temple piece 100, thus contouring at least in part to the temple piece. FIG. 11F shows a modification of FIG. 11C that may be employed when the buoyancy member is formed of a material with relatively low compressibility, such as Styrofoam®. To that end, FIG. 11F shows a modified buoyancy member 104K having the contour to accommodate the temple piece formed therein. The contoured portion of buoyancy member 104K may be produced during its formation, such as by conventional molding or casting, or may by machined into the buoyancy member 104K after its formation. The contour may be of various sizes and shapes, depending upon the anticipated size and shape of the eyeglass temple pieces to which the buoyancy member is to be applied.

FIGS. 11G and 11H show the use of a longitudinal resisting means applied to the embodiment of FIG. 11B in the form of string members 115A retained between float sheath 108 and buoyancy member 104J just above and below points 108A and 108B. As shown in perspective view in FIG. 11G, the longitudinal resisters 115A extend from each end of the buoyancy member, and may then be wrapped and/or tied around the temple piece to resist longitudinal movement of the buoyancy means. In an exemplary embodiment, the string members are formed of or are coated with a material that has increased frictional resistance to produce a low-slip surface, especially in the presence of water.

While there are some advantages to floatation means with a longitudinal passage, longitudinal slits or loops of a predetermined size in securing the means, there are many disadvantages. The ease of placement by trying to feed the temple piece through the passage can be cumbersome. The material creating the longitudinal passage is constantly stressed as the buoyancy means is applied and removed from the temple piece so it may break down over time. Many times a temple piece is not of uniform cross-sectional circumference along its length. For instance with a wire rim temple piece, the distal earpiece is considerably larger in circumference than the wire rim along the temple piece.

In this case, the passage has to expand to get past the larger distal earpiece and then contract and constrict around the wire rim and attempt to secure the floatation means to it. If the material surrounding the longitudinal passage is soft and flexible enough to get past the earpiece, it may not offer much constricting force or frictional resistance when it rebounds to the shape of the wire rim. Furthermore, since temple pieces come in such a wide range of circumferences, a buoyancy means that fits a wire rim snuggly may have a lot of difficulty fitting a temple piece on a different pair of eyeglasses with a huge circumference relative to the wire rim and may rip through or permanently alter the passage when the user attempts to feed the temple piece through the passage. Therefore, the longitudinal passage may restrict the ability of the user to use the buoyancy members interchangeably between different eyeglasses. The dilemma between selecting a durable buoyancy material and a flexible buoyancy material has been previously discussed. If the passage has a substantially minor portion on one side of it, this potential for rip through may be particularly relevant especially when the buoyancy member is structurally stressed by the constant application and removal of the buoyancy member and by waves stressing it in the ocean. Also in the longitudinal-passage floatation devices, there is a portion of the buoyancy material abutting the temple region of the wearer, so a soft, comfortable material is preferred. This may restrict the manufacturer from selecting a buoyancy material with more desirable floatation properties. Also a longitudinal passage may influence and restrict the overall shape of the buoyancy member. For instance, if the desired shape of the buoyancy member tapers to a point at one end, similar to the point of a cone, creating a longitudinal passage through a point is not possible. There has to be a sufficient volume of material through which a passage can pass. Also the resisting means later described as 115B would be impractical to apply to the buoyancy means with a longitudinal passage. Furthermore, the longitudinal passage determines where the buoyancy member will be placed relative to the temple piece and is predefined by its construction. Additionally, a minor portion of the buoyancy member medial to the longitudinal passage implies that there will be some bulk or volume of the buoyancy member medial to the temple piece which can affect the overall comfort for the wearer and possibly stress the temple piece itself.

The following embodiments were designed to address these potential disadvantages of a buoyancy member with a longitudinal passage. The construction of a buoyancy means that wraps around a temple piece addresses fitting and securing the buoyancy means to a wide variety of shapes and sizes of temple pieces on different eyeglasses and also allows it to be used interchangeably between the different eyeglasses without permanently altering the buoyancy means. The wrap-around embodiments also address a temple piece that does not have a uniform circumference or shape along its length. The sheath means and mating means can be tailored to fit the buoyancy member of any shape. Since there is no longitudinal passage, the shape of the buoyancy member is much more flexible. The medial side of the attachment means can be made with only a sheath or a sheath and a mating member where the temple piece abuts the face of the user, which minimizes the thickness of the buoyancy means proximate to the face, thereby improving comfort while simultaneously having a very durable structure at the thinnest portion of the buoyancy means. This also places minimal stress on the temple piece itself because it is not forced laterally away from the face trying to accommodate the thickness of a longitudinal-passage buoyancy member. This is particularly relevant in an eyeglass frame in which the temple pieces fit snuggly against the face of the wearer. The wrap-around embodiments of the buoyancy means overcomes the potential weakness of the offset passage in the longitudinal-passage embodiments. Furthermore, the resisting means can be incorporated in the interior part of the wrap-around embodiments which resists axial, vertical and rotational movement of the buoyancy means relative to the temple piece. The selection of the potential buoyancy material and its density is broader since the wrap-around embodiments can be made with no portion of the member medial to the temple piece. Also the attachment and retainer means can dually function as both the attachment means to secure the buoyancy means to the temple piece and the retainer means to secure a removable member.

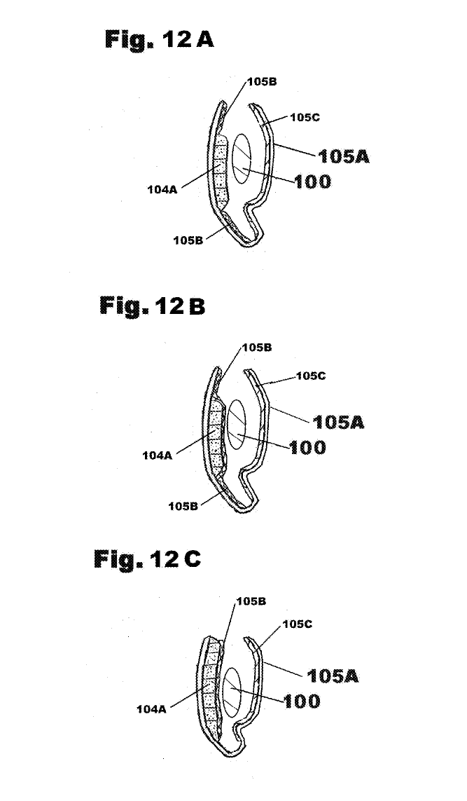

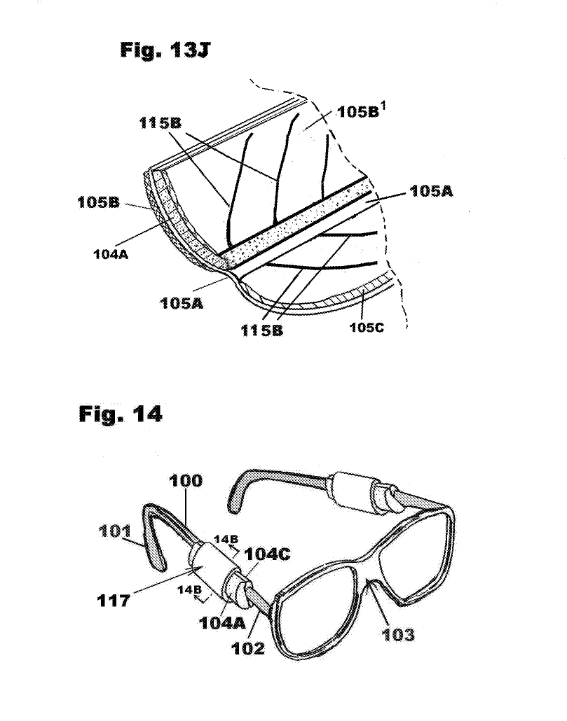

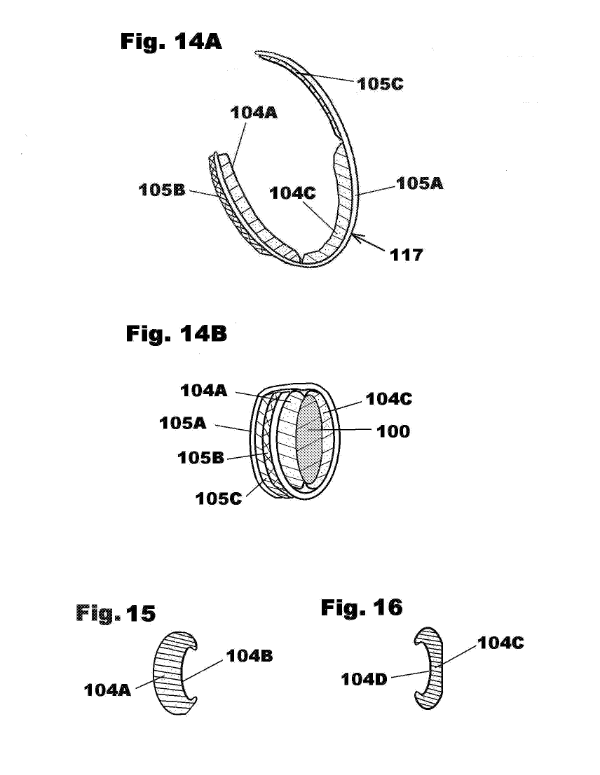

FIGS. 12-16 show embodiments wherein the buoyancy means has one or more buoyancy members 104A and/or 104C. The buoyancy members are retained to temple pieces 100 by means shown in FIGS. 13-13I and FIGS. 14-14B.

FIG. 12 shows a perspective view of the buoyancy means 105 applied over the temple piece 100. FIGS. 12A, 12B and 12C show embodiments in which the mating members are on the same side of the attachment and retainer sheath. Details of the buoyancy means 105 are shown in FIGS. 13 and 13A-13C. The bulge in the lateral aspect of the buoyancy means where cross section 13B is taken demonstrates the selective placement of the removable means. It is easy to contemplate the ability to position the weight member and/or the secondary buoyancy member anywhere along the length of the attachment and retainer means between the mating members 105B and 105C. In this case, the attachment means dually functions as the retainer means. In a preferred embodiment, mating members 105B and 105C are hook/loop members such as Velcro®. To achieve the desired floatation effects, the user may elect to add the weight member to the proximal end and the secondary buoyancy member to the distal end of the buoyancy means.

FIG. 13 shows details of the buoyancy means 105 of FIG. 12 prior to its attachment to the temple piece 100. Buoyancy means 105 comprises an elastomeric attachment and retainer sheath 105A, such as Spandex®, with mating members 105B and 105C attached on opposite surfaces and ends of sheath 105A by any conventional methods, such as sewing or bonding. Buoyancy means 105 additionally includes the buoyancy member 104A, which is attached to the elastomeric attachment and retainer sheath 105A on the same surface but opposite end as mating member 105C. For purposes of discussion, the buoyancy member is attached to the inner surface of the attachment and retainer sheath and the opposite surface will be referred to as the outer surface.

FIG. 13A shows the buoyancy means 105 of FIG. 13 applied to eyeglass temple piece 100. Mating members 105B and 105C contact each other to secure the attachment of the floatation means to the temple piece 100.

FIG. 13B shows a modification of FIG. 13A, wherein the removable means is disposed between the mating members 105B and 105C. FIG. 13C shows details of the removable means. Member 116 has mating members 116A and 116B bonded to opposite surfaces thereof which engage the mating members 105B and 105C and can be applied anywhere along the length of the buoyancy means to achieve the desired floatation effects. Alternately, the additional buoyancy member or the weight member can be secured between members 105B and 105C without bonding the mating member directly to the removable member 116. In this case, the attachment and retainer means dually functions the attachment means and as the retainer means.

FIG. 13D shows a modification of the embodiment shown in FIG. 13 in which the mating an additional mating member 105B¹ is secured to the buoyancy member 104A and mating member 105C is extended to proximate buoyancy member 104A. This accommodates temple pieces of various sizes, thicknesses and shapes and allows the buoyancy means to be placed at any desired position both vertically and longitudinally along the temple piece as shown in FIG. 13E and FIG. 13H.

FIGS. 13F and 13I show the hook means 105D used to initially secure the buoyancy means to the temple piece by creating a purchase point to begin wrapping the attachment and retainer sheath around the temple piece and buoyancy member. The hook means helps to align the superior part of the buoyancy means with the superior part of the temple piece, provides frictional resistance for longitudinal stabilization of the buoyancy means and facilitates placement of the buoyancy means. The hook means 105D is made of a material which has sufficient resiliency to allow it to conform to the temple piece and sufficient rigidity to permit it to secure initial attachment of the buoyancy means to the temple piece. An exemplary embodiment of the hook means incorporates a surface which has frictional resistance which resists longitudinal or rotational movement of the buoyancy means along the temple piece. Hook means 105D can be secured to the buoyancy means by being embedded in the buoyancy member 104A or could alternately be attached between any of the layers 105B-105A, 105A-104A or 104A-105B¹ by any conventional method such as bonding. Hook means 105D can be made of a rubber, synthetic rubber, plastic or wire coated with a material which protects the temple piece from being scratched and also offers frictional resistance. Hook means 105D can be placed at multiple places along the buoyancy means such as its distal end, proximal end and any intermediate points there along or it can extend the entire length of the buoyancy means.

FIG. 13G shows an alternate way to initially secure the buoyancy means to the temple piece via the mating means. Mating member 105B², which is an extension of external mating member 105B, extends beyond the attachment and retainer sheath 105A and has mating member 105C¹ attached to it by any conventional means, such as by bonding or stitching, in a manner in which the backing (non-mating) surface of 105B² contacts the backing (non-mating) surface of 105C¹. This means that the mating surfaces of 105B² and 105C¹ face in opposite directions and are not engaged. Members 105B² and 105C¹ form a securing flap to initially secure the buoyancy means to the temple piece. When the securing flap is folded over the temple piece, mating member 105C¹ engages internal mating member 105B¹ inferior to the temple piece to initially secure the buoyancy means to the temple piece, then mating member 105C is wrapped in the opposite direction and engages mating member 105B² when the attachment and retainer sheath is folded around the temple piece and the buoyancy member and finally mating member 105C engages the external mating member 105B. As with the hook means, the securing flap can extend the entire longitudinal length of the buoyancy means or a portion of it and can be a single structure or can be plural securing flaps positioned at points along the length of the buoyancy means.

FIG. 13H shows a perspective view of the application of the buoyancy means shown in FIG. 13E to the temple piece. Also shown are hidden removable buoyancy member 116¹ and removable weight member 116² retained by the mating attachment and retainer means of the buoyancy means. In this embodiment and the following embodiments, the attachment and retainer means can dually function as both the attachment means and the retainer means. This drawing depicts that both removable members can be simultaneously added at any position along the length of the buoyancy means. In an exemplary embodiment, the removable means are positioned within the attachment and retainer means to maximize visibility of the floating eyeglasses.

FIG. 13J shows a perspective view of the interior aspect of FIG. 13D with the addition of resisting means 115B. Resisting means 115B is shown as angled strips in FIG. 13J but could run horizontally, vertically, grid shaped, curved or freeform along the interior of the buoyancy means in the zone where the temple piece is contemplated to be placed. Resisting means 115B can be used in any embodiments in which the buoyancy means is wrapped around the temple piece such as those shown in FIGS. 13-13J, FIGS. 14-14B and FIGS. 17-21. In FIG. 13G, the resisting means could be attached to the surface of 105C¹ which contacts the temple piece. Resisting means 115B can be attached to the mating members and/or sheaths and/or buoyancy members of the buoyancy means by any conventional method such as bonding or stitching. In an exemplary embodiment, their placement will ensure sufficient frictional resistance in the area that the temple piece is contemplated contacting the buoyancy means to resist axial, vertical and rotational movement of the buoyancy means. The resisting means has a highly frictional surface meant to contact the temple piece and offer resistance to movement in the longitudinal, and/or vertical and/or rotational directions. An exemplary embodiment has the resisting strips constructed of a material such as a rubber or a synthetic material which has a high coefficient of friction in the presence of water. The resisting means are attached to mating members 105B¹, 105C¹ and 105C by any conventional means such as bonding or stitching on where the temple piece will contact the interior of the buoyancy means. The mating members firmly press the resisting strips against the temple piece or the temple sheath surrounding the temple piece creating the frictional points of contact which will help resist the movement of the buoyancy means on the temple piece. In an exemplary embodiment, the positioning and thickness of the resisting means takes into account the creation of increased frictional resistance while allowing sufficient contact of the mating members to press the resisting means against the temple piece. Because axial positioning of the buoyancy means along the temple piece is a factor in creating a desirable tipping angle, this exemplary embodiment of the buoyancy means helps the buoyancy means remain where it is positioned on the temple piece when it is subjected to external forces such as waves in the ocean. Since the resisting means is on the interior surface of the buoyancy means, once the buoyancy means is applied to the temple piece, the resisting means is not apparent visually and does not detract from the cosmetic appearance of the buoyancy means.

FIG. 14 shows a modification of FIG. 12, wherein the buoyancy means 117, which contains plural buoyancy members 104A and 104C, is retained to the temple piece 100.

FIGS. 14A and 14B show details of the buoyancy means 117 of FIG. 14, which is similar in construction to floatation means 105 of FIG. 13. Buoyancy members 104A and 104C are attached by any conventional means such as bonding to attachment and retainer sheath 105A on the same surface as the mating member 105C. FIG. 14B shows floatation means 117 applied to an eyeglass temple piece 100 in a manner similar to that of floatation means 105 of FIG. 13A. While FIGS. 14A and 14B show two buoyancy members 104A and 104C, any number of additional buoyancy members may be provided and similarly attached to member 105A.

FIGS. 15 and 16 show a modification of the buoyancy members 104A and 104C of FIGS. 12-14, wherein the buoyancy members 104A and 104C include contour portions 104B and 104D, respectively, contoured to conform to temple piece 100, thus promoting a snug fit of the buoyancy members against the temple pieces. Contour portions 104B and 104D may be particularly desirable in the event the buoyancy members 104A and 104C are formed of a relatively incompressible material, such as Styrofoam®, which does not readily deform. Contours 104B and 104D may be created during formation of the buoyancy members, such as by conventional casing or molding thereof, or may be machined as cutouts after formation of the buoyancy members. FIG. 16 additionally shows a planar face on buoyancy member 104C to reduce the bulk of the buoyancy member towards the user's temple region and to produce rotational stability.

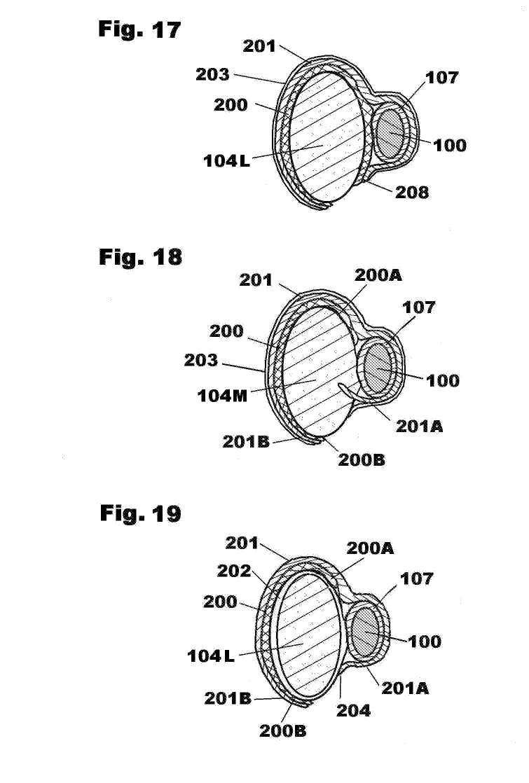

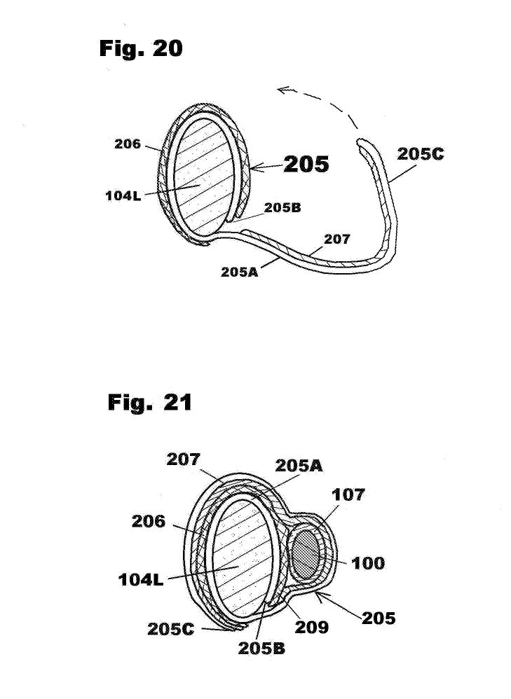

FIGS. 17-21 show alternate embodiments of the buoyancy means, wherein the buoyancy member, in various embodiments, is secured external of the temple piece 100. In each of FIGS. 17-21, the removable means 116 of FIG. 13C may optionally be applied at the user's discretion between the mating members of the attachment and retainer means at a desired position to promote upward tipping of the distal end 101 of the temple pieces 100, and downward tipping of lens frame portion 103. FIG. 17, FIG. 20 and FIG. 21 show an embodiment in which the buoyancy means can be attached at a desired vertical position relative to the temple piece by determining where the mating members are engaged below or above the temple piece. The buoyancy member shown in FIGS. 17-21 can be of any shape and can also have the resisting means 115B attached to surfaces in which the temple piece (with or without temple sheath 107) is contemplated contacting the interior of the buoyancy means.

FIG. 17 shows the attachment of buoyancy member 104L to temple piece 100. Internal mating attachment and retainer member 200, which in and exemplary embodiment is formed of a conventional hook and loop material, such as Velcro®, is attached to the buoyancy member 104L by any conventional method, such as bonding. External mating attachment and retainer member 201, in and exemplary embodiment is also comprised of a conventional hook and loop material, surrounds temple piece 100 and internal mating attachment and retainer member 200. In a further modification of the buoyancy means, external member 201 may additionally be attached to internal mating attachment and retainer member 200 at point 208 by any conventional method, such as stitching. The elastomeric attachment and retainer sheath 203, formed of a material such as Spandex®, may additionally be attached to mating attachment and retainer flap member 201, and is preferably brightly colored to promote visibility of the buoyancy means when in the water.

FIG. 18 shows an optional means for securing the external mating attachment and retainer flap member 201 to the buoyancy member 104L. In this embodiment, end 201A of external mating attachment and retainer flap member 201 is embedded within the buoyancy member 104M. Internal mating attachment and retainer member 200 may terminate above the temple piece 100, as shown in FIGS. 18 and 19, but may optionally extend below the temple piece 100, as shown in FIG. 17.

FIG. 19 shows an optional means of attachment of the external mating attachment and retainer flap member 201 to the buoyancy member 104L. In this embodiment, the resilient float sheath 202 surrounds and is attached to the buoyancy member 104L. Internal mating attachment and retainer member 200 is attached to sheath 202. End 201A of mating attachment and retainer flap member 201 is attached, such as by stitching or bonding, to float sheath 202 at point 204. Internal mating attachment and retainer member 200 may terminate above the temple piece 100, as shown in FIG. 19, but may optionally extend below the temple piece 100 as shown in FIG. 17.

FIGS. 20 and 21 show an alternate embodiment of the buoyancy means, wherein buoyancy means 205 is attached to each temple piece 100. FIG. 20 shows buoyancy means 205 prior to attachment to temple piece 100. Buoyancy means 205 comprises the sheath means 205A of flexible elastomeric material with a mating attachment and retainer member 206 attached on one side and end of the sheath, and a mating attachment and retainer flap member 207 attached on the opposite side and end of the sheath. Sheath means 205A is preferably brightly colorized. 205B and 205C identify opposite ends of the sheath 205A for orientation purposes. Sheath means 205A is attached to the buoyancy member 104L, as shown in FIG. 20.

FIG. 21 shows the buoyancy means 205 of FIG. 20 applied to an eyeglass temple piece 100. Sheath means 205A with attached mating attachment and retainer member 207 surrounds temple piece 100 and continues circumferentially around and over the buoyancy member 104J, with mating attachment and retainer flap member 207 engaging mating attachment and retainer member 206. As shown in FIG. 21, end 205B of sheath means 205A extends below temple piece 100, but may optionally terminate above the temple piece 100 in a manner similar to mating attachment and retainer member 200 shown in FIG. 18. Additionally, end 205C of sheath means 205A is shown in FIG. 21 as terminating at a point below the buoyancy member, but may optionally extend circumferentially to a position proximate end 205B. Extra rigidity may be obtained by attachment of mating attachment and retainer members 206 and 207 by any method, such as stitching, at point 209 below the temple piece.

What is claimed is:

1. The combination of a pair of eyeglasses and visibility means for promoting the visibility of the eyeglasses, wherein the visibility means comprises at least in part a separate sheath means for each eyeglass temple piece wherein the separate sheath means is removably attached to and surrounds at least a portion of the temple piece and wherein the sheath means includes a flexible temple sheath.

2. The combination of claim 1 wherein the temple sheath is formed at least in part of an elastomeric material.

3. The combination of claim 1, wherein the sheath means surrounds at least a portion of the distal end of the temple piece.

4. The combination of claim 1, wherein each sheath means is brightly colorized, and/or reflective, and/or luminescent over at least a portion thereof.

5. The combination of claim 3 wherein the visibility means further includes at least one buoyancy means having an overall specific gravity of less than one, wherein the buoyancy means includes at least one buoyancy member, and attachment means for removably securing the buoyancy means to an eyeglass temple piece.

6. The combination of a pair of eyeglasses and visibility means for promoting the visibility of the eyeglasses, wherein the visibility means comprises at least in part separate buoyancy means for effecting floatation of eyeglasses when in the water, wherein each buoyancy means comprises at least one buoyancy member, a sheath and first and second mating members, wherein at least a portion of the buoyancy member is attached to at least a portion of the sheath and at least a portion of the first mating member is attached to at least a portion of the sheath and wherein at least a portion of the second mating member is attached to at least a portion of the sheath and/or at least a portion of one buoyancy member.

7. The combination of claim 6 wherein the buoyancy member is attached to the first end and the first side of the sheath and wherein at least a portion of the first mating member is attached to the first end and the second side of the sheath and wherein the second mating member is attached to the same side and the second end of the sheath.

8. The combination of claim 7, wherein an additional first mating member is attached to at least a portion of the buoyancy member.

9. The combination of claim 8 wherein at least a portion of the first mating member extends beyond and is unattached to the sheath and an additional second mating member is attached to the portion of the first mating member which is unattached to the sheath.

10. The combination of claim 6, wherein the first and second mating members comprise hook/loop members.

11. The combination of claim 6 in which a resisting means is applied to at least a portion of the surface of the buoyancy means which will come into frictional contact with the temple piece and/or the temple sheath surrounding the temple piece.

12. The combination of claim 6 in which a personalization means is applied to the buoyancy means.

13. The combination of claim 6 further including an elastomeric temple sheath applied to at least a portion of each temple piece.

14. The combination of claim 6 wherein a removable means is applied to the buoyancy means.

15. The combination of a pair of eyeglasses and visibility means for promoting the visibility of the eyeglasses, wherein the visibility means comprises at least in part separate buoyancy means for effecting floatation of eyeglasses when in the water, wherein the buoyancy means has a specific gravity less than one which comprises at least one buoyancy member and attachment means for removable attachment of the buoyancy means to an eyeglass temple piece at any desired position, and a retainer means comprising a mating means to secure a removable means to the buoyancy means.

16. The combination of claim 15, wherein the retainer means comprises a sheath, and further comprises first and second mating means attached to the sheath.

17. The combination of claim 15, additionally comprising at least one removable means disposed within the retainer means.

18. The combination of claim 15 in which the buoyancy means has a longitudinal passage as the attachment means.

19. The combination of claim 18 in which the at least a portion of the longitudinal passage is offset from the center of volume of the buoyancy member.

20. The combination of claim 15 further including an elastomeric temple sheath applied to at least a portion of each temple piece.

21. A method for providing visibility to eyeglasses comprising the step of applying a buoyancy means to each temple piece of a pair of eyeglasses, and further comprising selectively applying a removable means to at least a portion of the buoyancy means without bonding thereto.
